(19) United States
(12) Patent Application Publication
(10) Pub. No.: US 2018/0314510 A1
(43) Pub. Date: Nov. 1, 2018

(54) SYSTEM FOR DISTRIBUTING COMPONENTS

(71) Applicant: GOOGLE INC., Mountain View, CA (US)

(72) Inventors: Rahul Roy-Chowdhury, Redwood City, CA (US); Dan Chen, Kirkland, WA (US); Qian Huang, Sammamish, WA (US)

(73) Assignee: GOOGLE INC., Mountain View, CA (US)

(21) Appl. No.: 14/273,137

(22) Filed: May 8, 2014

(51) Int. Cl. G06F 9/445

(52) U.S. Cl. CPC G06F 8/65

(57) ABSTRACT

A method and system include providing a staged release of multiple components of a native application, updating at least one of the multiple components. The updating may occur over multiple channels for each updated component. The multiple channels correspond to different builds of the native application.

### TECHNICAL FIELD

This application generally relates to web technology, and more particularly, to distributing components related to web technology.

### BACKGROUND

A native application, such as a web browser, may require installation and updates of various components. Often, such installation and updating requires a user to download and install a large file when an update to any aspect of the native application is required. Such a download may require more bandwidth, time, or memory than is necessary for a particular update, or for a particular user who may not use all features of a particular native application and therefore may not wish to install such a large file. Additionally, updates are often distributed to all users at once, rather than to particular sets or groups of users, which may be less than optimal for developers. Furthermore, not all users may want installation of every component of a native application, or of all components at the same time. For example, some users may wish to install certain components on demand.

### SUMMARY

Systems and methods provide a staged release or on demand release and installation of components of a native application such as a web browser.

A method includes providing a staged release of multiple components of a native application, updating at least one of the multiple components. The updating may occur over multiple channels for each updated component. The multiple channels may correspond to different builds of the native application.

Implementations may include one or more of the following features, alone or in combination with each other.

Each of the multiple components may be associated with its own unique private key. A digital marketplace server may store the unique private key. The digital marketplace server may also store the components. The updating may be performed based on a schedule. The native application may be a web browser. The updating may be performed without an update of another of the multiple components. Each of the multiple components may comprise binary code that depends on a specific operating system. The update may be released to a percentage of users of the native application, the percentage being less than 100% of all users. The percentage may be specified by a team managing the at least one component. The updating may be scheduled by the team managing the at least one component. The method may also include updating a second of the multiple components by a second team managing the second of the multiple components. The at least one component may include a voice recognition binary or a media player binary.

Other implementations include corresponding systems, apparatus, and computer programs, configured to perform the actions of the methods, encoded on computer storage devices.

One or more of the implementations of the subject matter described here may provide one or more of the following advantages. Each component of the native application may have its own update cycle. There is no required manual update in one central location every few weeks or based on one set schedule. The system can instead push out a new component binary at any time. Additionally, the system minimizes download payload by only updating necessary components, instead of updating the entire application or all components at once. Users, instead of having to download entire package, can get a recomposed package.

### BRIEF DESCRIPTION OF THE DRAWINGS

FIG. 1 is a block diagram illustrating an example system that distributes components of a native application.

FIG. 2 is a sequence diagram illustrating an example of a system implementing component distribution.

FIG. 3 is a block diagram of an example of a cryptographic exchange of information between an updater and a digital marketplace server.

FIG. 4 is a flowchart illustrating a process for a system to distribute components of a native application.

FIG. 5 is a diagram illustrating a computing device and a mobile computing device that can be used to implement the techniques described here in accordance with an example embodiment.

Like reference symbols in the various drawings indicate like elements.

### DETAILED DESCRIPTION

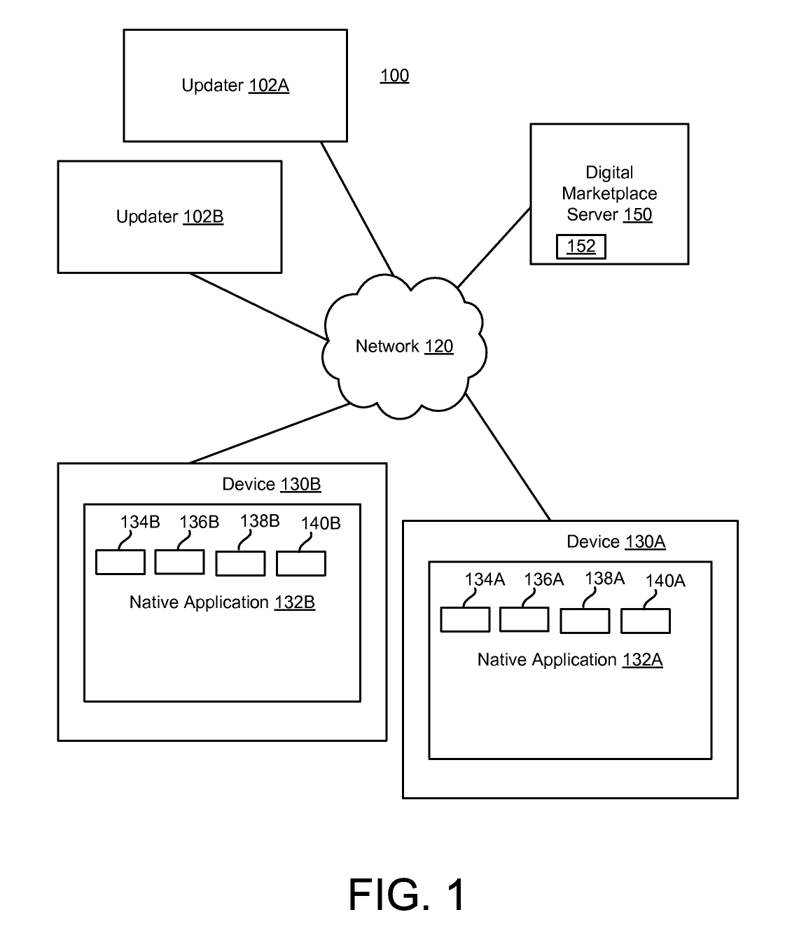

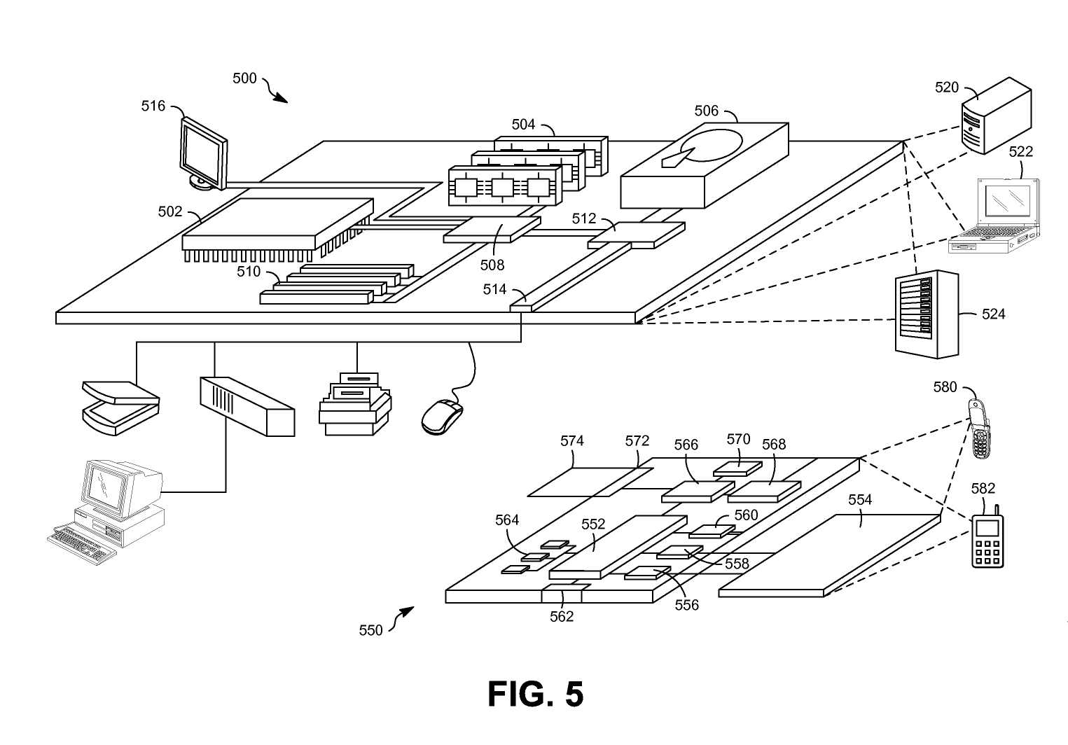

FIG. 1 is a block diagram illustrating an example system that distributes components of a native application. The system 100 may include an updater 102A, an updater 102B, a device 130A, a device 130B, and a digital marketplace server 150, which are interconnected through at least one network 120. The updaters 102A and 102B may be computing devices operated by developers of digital goods. The devices 130A and 130B may be computing devices operated by users of digital goods. The devices 130A and 130B may represent virtually any computing device that may be configured to execute a native application, and to communicate with the digital marketplace server 150. For example, the devices 130A and 130B may include a standard desktop or personal computing device, a laptop, notebook, or netbook computer, a tablet computer, or a smartphone, television, or other mobile computing device. Additional examples of computing devices are described in more detail below with respect to FIG. 5. The network 120 may be a local area network (“LAN”), a wide area network (“WAN”), or the Internet.

The digital marketplace server 150 may be a server that stores information and data, and that executes an operating system and various applications and services to provide functionality to the devices 130A and 130B and updaters 102A and 102B. For example, in one implementation, the digital marketplace server 150 may include a digital goods repository 152 (e.g., a database or other data store), and digital goods or updates associated with the digital goods may be served from, or downloaded from, the repository to the client computing devices. For example, digital goods may be downloaded in a binary or packaged file, such as a .CRX file or a .ZIP file. Digital goods may include binaries of web browsers, components of web browsers, or web applications, or web browser extensions, as examples. In another implementation, the digital goods, updates, and related data may be stored in, and served to devices from, a repository that is remotely located from the digital marketplace server 150. For example, digital goods could be stored and served to devices from individual repositories that are operated and controlled by developers of the digital goods, and digital goods repository 152 of the digital marketplace server 150 may provide a reference to the individual repositories that are operated by the developers.

The devices 130A and 130B may include native applications 132A and 132B. One example of a native application is a web browser. A web browser executed by a device can receive code (e.g., HTML code) from a remote server (e.g., a remote server that hosts a website) and can execute the receive code on the device for the benefit of a user of the device.

Other examples of native applications include word processing applications, photo editing applications, or video games. The native application 132A includes components 134A, 136A, 138A, and 140A. The native application 132B includes components 134B, 136B, 138B, and 140B. Components, as referred to herein, mean binarys that depend on specific machine environments. Components do not depend on each other and can be updated separately. Components can be function blocks of a web browser, for example. Example components include Native Client (NACL), Portable Native Client (PNACL), voice recognition language modules, Digital Rights Management (DRM) features, optional libraries, media players such as Pepper_FLASH players, WidevineCDM, a recovery feature, or CRLSet. A recovery component may monitor browser crashes, recover a process and a user state. A CRL is a certificate revocation list of certificates that have been revoked, and a CRLSet component provides a way in which a browser can block a public key, digital, or identity certificate.

Unlike third party plug-ins, components do not require a public standard interface. A web browser can execute without components, and the web browser may have a smaller initial download without components. Components can be downloaded on demand. A component can be published or patched individually, without updating a portion of the entire browser binary. In this way, a component binary and a browser binary are highly decoupled. A binary is a computer file that is executable without compilation or interpretation. A binary may contain any type of data, encoded in binary form for computer storage and processing purposes. Native Client (NACL) is a sandbox for running compiled C and C++ code in a web browser efficiently and securely, independent of a user's operating system. Portable Native Client (PNACL) extends that technology with architecture independence, letting developers compile code once to run in any website and on any architecture.

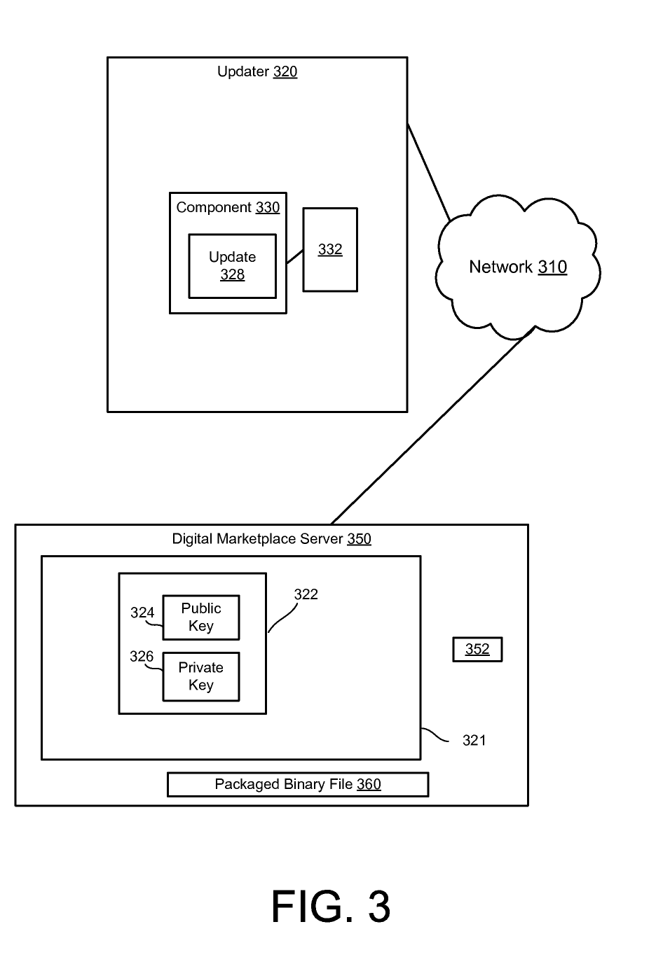

Each component may be associated with its own unique private key, which may be generated by a development team or updater such as the updater 102A or the updater 102B as described in more detail below with respect to FIG. 3. Each private key may be stored and managed by the digital marketplace server 150, for example in the digital goods repository 152 or in another data store associated with the digital marketplace server 150. In this way,

In various implementations, the system 100 may include additional devices or servers. For example, the system 100 may include a download server (not shown) that receives packaged files from the digital marketplace server 150, and the download server may send the packaged file to the device 130A and to the device 130B.

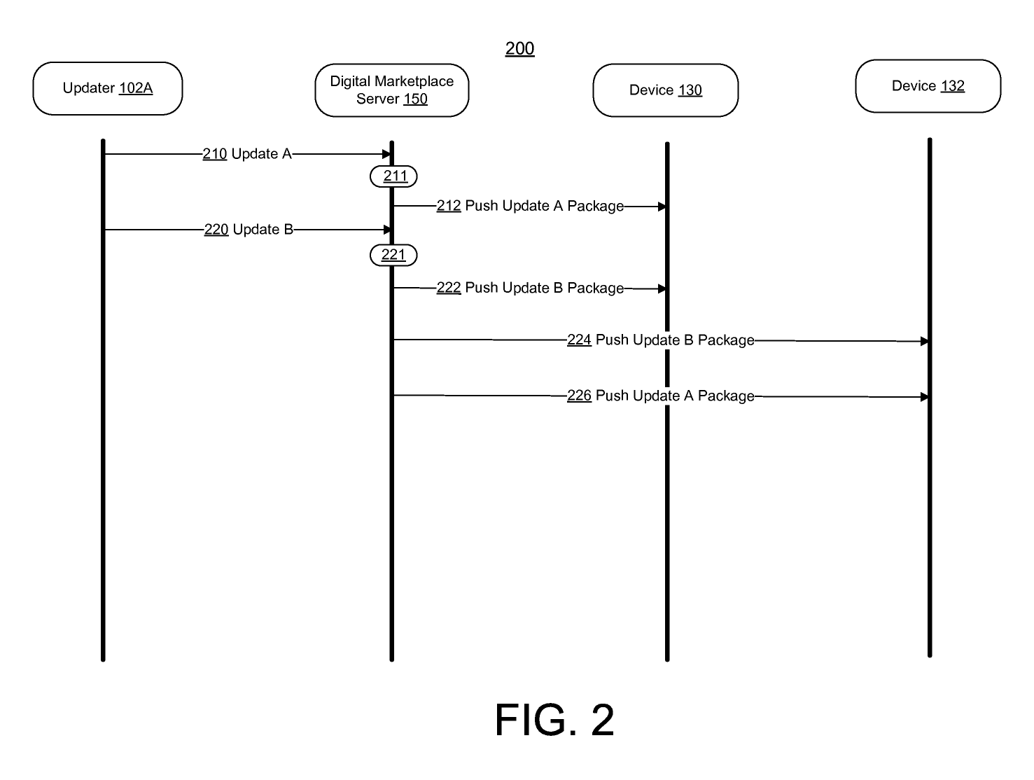

FIG. 2 is a sequence diagram illustrating an example of a system implementing component distribution. The system 200 may include the updater 102A, the digital marketplace server 150, the device 130 and the device 132. The updater 102A may be the updater 102A as described above with respect to FIG. 1. The digital marketplace server 150 may be a server such as the digital marketplace server 150 described above with respect to FIG. 1. The devices 130 and 132 may be a computer, such as a smartphone or laptop, such as described above with respect to FIG. 1, and which may execute applications.

As shown in FIG. 2, the updater 102A, at time 210, may push an Update A to a digital marketplace server 150. The Update A may relate to at least one component of a native application, such as the native application 132A shown in FIG. 1. The Update A may be a binary, as one example, related to a component of the native application 132A.

At time 211, the digital marketplace server 150 may use the binary content of Update A to generate an Update A package, which may be a binary such as a .CRX or .ZIP file.

At time 212, the digital marketplace server 150 may push the Update A package to the device 130. In additional or alternative implementations, the digital marketplace server 150 may push the Update A to another server (not shown), which in turn may send a package of the Update A to a device.

At time 220, the updater 102A may push Update B to the digital marketplace server 150. The Update B may include binary content related to at least one component of a native application, such as the native application 132A shown in FIG. 1. The Update B may relate to the same or a different component as the Update A.

At time 221, the digital marketplace server 150 may use the binary content of the Update B to generate an Update B package, which may be a binary. At time 222, the digital marketplace server 150 may push the Update B package to device 130. At time 224, the digital marketplace server may push the Update B package to device 132. At time 226, the digital marketplace server may push the Update A package to device 132.

The system 200 also supports delivering updates or releases of components on demand based on a request from a user or a device. For example, a user may wish to delay installation of a particular component or of a particular component update, such as the Update A. Later, the user may request the update at a different point in time. Upon receiving the request from the user, the digital marketplace server 150 may push the update to the user and/or all of a user's devices based on a user account. In some implementations, a user may delay or schedule various updates for a future time (e.g., update all pending component updates at 8:00 each morning).

In some implementations, users may request an installation of a component on demand. For example, a user may not wish to install a FLASH player when installing a web browser, but may later decide to install the FLASH player to view movies. At the later time, the user may request download or installation of the FLASH player component, and the digital marketplace server 150 may automatically respond to the request by sending the latest version of the component to the user at that time.

The examples illustrated in FIG. 2 are merely illustrative. The system 200 may push updates to various devices at the same time or at different times, and other implementations are possible. For example, the digital marketplace server 150 may push Update A and Update B to device 130 and device 132 at the same time.

In various examples, each development team for a component of a native application manages its own component and corresponding release or update schedule. The teams may update various components over multiple channels. Channels, as described herein, include transmission paths along which data can be transmitted between a central processing unit (for example of a server, such as the digital marketplace server 150), and one or more devices (such as the device 130 or the device 132). Channels may be used for releases or updates of components. Illustrative examples of channels include a “Beta” channel, a “Stable” channel, and a “Development” channel. A Beta channel may be for users that want latest developments. A Development channel may exist for developers to test changes to program. A Stable channel may exist for most users. Other examples of channels include channels corresponding to web browser builds or to operating system versions (such as v.1.1, v 1.2). For example, an update may be first released to version 1.0 on a Beta channel, and a later be released to version 1.2 on a Stable channel. Updaters can also control a percentage of users who receive an update on each channel.

As one example, team Alpha can distribute latest version of component “Alpha” to 10% of Dev channel users at 5:00 PM today. Team Alpha can then increase the percentage of users to 50%, can roll out the component to other channels, and can perform other actions. As another example, team Alpha can also control the percentage distribution on each channel (e.g., Beta Channel, Stable Channel, etc.), or can control which regions or countries first receive the component. As one example, team Alpha can decide that only users or devices in the United States users will receive the component today.

Instead of having to download an entire packaged file for an updated version of an entire native application, users can get a recomposed packaged file including the update. Advantages of the system include that each component has its own update cycle, and that there is no longer a manual update in one central location every six weeks or based on one set schedule. Moreover, teams can instead push out new component binary at various times. Additionally, the system 200 minimizes download payload for each user, by only updating certain components rather than an entire native application at once, thus minimizing a size of the download of a binary.

FIG. 3 is a block diagram of an example of a cryptographic exchange of information between an updater and a digital marketplace server. An updater 320, which may be the updater 102A as shown above in FIG. 1, include at least one computing device associated with a development team for a specific component 330 of a native application 332. The updater 320 may generate an update 328 for the component 330.

The digital marketplace server 350 may include a cryptographic key generator 321. The cryptographic key generator 321 generates a key pair 322 including a public key 324 and a private key 326, which may both be associated with a particular component 330 of the native application 332. The updater 320 may send the digital marketplace server 350 a file, such as a .ZIP file, containing binary content for the update 328, via the network 310. The updater 320 may send the file encrypted with the public key 324.

The digital marketplace server 350 may store a private key 326 in a data store 352, which may be a secure data store. A centralized webstore such as the digital marketplace server 350 may store various components and associated updates, which may each be signed by a unique private key. The private key 326 may be used, for example, to verify the authenticity of the update 328 before it is distributed to a device such as the device 130A shown in FIG. 1.

As one example, the digital marketplace server 350 may utilize the private key 326 to verify the update 328 for the component 330 that was received from the updater 320. The digital marketplace server 350 may use the private key 326 to verify that the update 328 relates to a verified component 330 that is stored in the data store 352. The digital marketplace server 350 may then generate a packaged binary 360, such as a .CRX file, to distribute the update to devices, for example by sending the update directly to the devices, or by sending the update using another download server (not shown). In various implementations, the digital marketplace server 350 may use the private key 326 to sign the packaged binary 360.

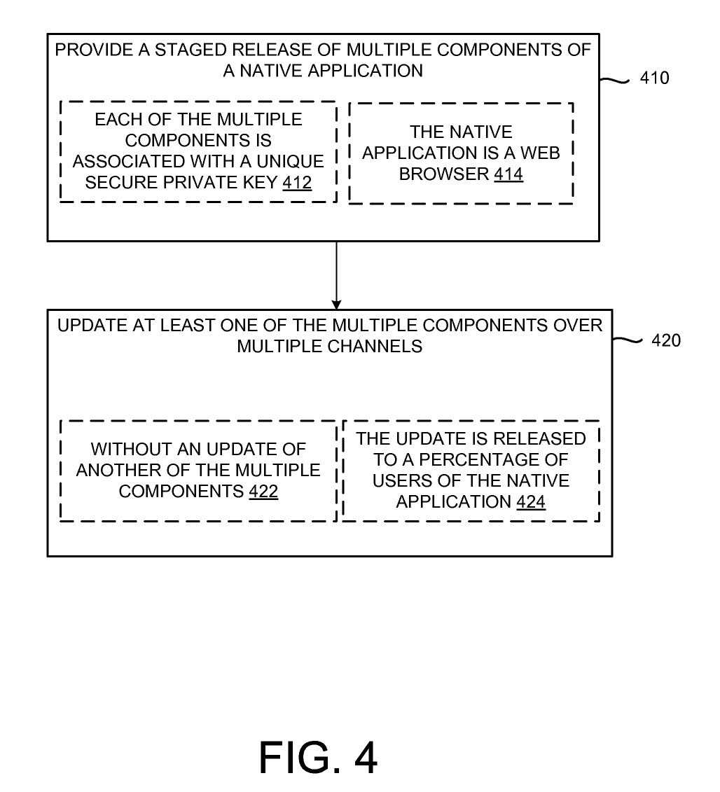

FIG. 4 is a flowchart illustrating a process for a system to distribute components of a native application. The process illustrated in FIG. 4 may be performed at least in part by the system 100 shown in FIG. 1, for example using the digital marketplace server 150 and the updater 102A. The system may provide a staged release of multiple components of a native application (410). The native application may be, for example, the native application 132B shown in FIG. 1. The multiple components may include components 134B, 136B, 138B, and 140B shown in FIG. 1. Each of the multiple components may be associated with a unique private key (412) such as the private key 326 as described above with respect to FIG. 3. The native application may be a web browser (414).

The system may update at least one of the multiple components over multiple channels (420). For example, as described above with respect to FIG. 2, the system may push an Update A at time 212 over a first channel (not shown), and may push an Update B at time 222 over a second channel (not shown). Alternatively or additionally, the system may push Update A and Update B over the same channel, but at different times.

Implementations may include one or more of the following features, alone or in combination with each other. The system may update the at least one of the multiple components without an update of another of the multiple components (422). For example, as described above with respect to FIG. 2, the system may push an update for component A without pushing an update for component C (not shown). The update, such as the Update A, may be released to a percentage of users of the native application (424). For example, the update may be released to 10% of users at a time. In some examples, the update may be released on a regular schedule, such as to 10% of users each hour until 100% of users are reached. In other examples, a developer or team may designate percentage of users without any scheduled updates. The schedule(s) may be decentralized such that various teams may adjust various aspects of the schedule(s) for one or more components. Further, updates are not required to performed in a particular sequence. In some examples, less than 100% of users may receive an update for a particular component. Other variables may be used, such as pushing an update to all users or devices located in the United States, or to all users or devices located in Japan.

The system may support staged release to 50% of users first, gradually increasing to 100%, which may control a rollout speed, without causing a network spike, and which may reduce costs.

The system may support delivering different updates, including binaries, based on a type of operating system or system architecture. For example, system architectures may include ARM, x86, and different binaries may be delivered to an ARM architecture as compared to an x86 architecture. The system may also support delivering different updates based on a device's machine bits, such as 32-bit or 64-bit, such that a 32-bit machine receives a different binary than a 64-bit machine. In such examples, components may be binary code that depends on specific machine environments.

FIG. 5 is a diagram that shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The devices shown here, their connections and relationships, and their functions, are meant to be examples of devices described above with respect to FIGS. 1-4, such as the updater 102A, the device 130A, or the digital marketplace server 150.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the apparatuses 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a non-transitory computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is for illustration only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, apparatuses from computing device 500 may be combined with other apparatuses in a mobile device (not shown), such as device 550. Each of such devices may contain one or more of computing device 500, 550, and an entire system may be made up of multiple computing devices 500, 550 communicating with each other.

Computing device 550 includes a processor 552 (e.g., a solid-state based microprocessor), memory 564, an input/output device such as a display 554, a communication interface 566, and a transceiver 568, among other apparatuses. The device 550 may also be provided with a storage device, such as a microdrive or other device, to provide additional storage. Each of the apparatuses 550, 552, 564, 554, 566, and 568, are interconnected using various buses, and several of the apparatuses may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other features of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, which may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used here, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end computer (e.g., as a data server), or that includes a middleware computer (e.g., an application server), or that includes a front end computer (e.g., a client computer having a graphical user interface or a Web browser through which a user can interact with an implementation of the systems and techniques described here), or any combination of such back end, middleware, or front end computers. The aspects of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other features may be added to, or removed from, the described systems. Accordingly, other implementations are within the scope of the following claims.

1. A method comprising:
providing a staged release of multiple components of a native application, the staged release of each component including pushing the component to different groups of users of the native application at different times, each group including less than 100% of users of the native application and wherein the times are different for different components of the native application;
updating at least one of the multiple components,
wherein the updating occurs over multiple channels for each updated component, the multiple channels corresponding to different builds of the native applications, and
wherein pushing the component to different groups of users of the native application at different times includes:
receiving an update file including binary content from an updater computer on which the update file was created;
generating an update package from the binary content, the update package being configured to automatically install the component on a device that runs the native application; and
sending the update package to a first group of users at a first time and a second group of users at a second time.

2. The method of claim 1, wherein each of the multiple components is associated with its own unique private key.

3. The method of claim 2, wherein a digital marketplace server stores the unique private key.

4. The method of claim 3, wherein the digital marketplace server stores the multiple components.

5. The method of claim 1, wherein the native application is a web browser.

6. The method of claim 1, wherein the updating is performed without an update of another of the multiple components.

7. The method of claim 1, wherein each of the multiple components comprise binary code that depends on a specific operating system.

8. The method of claim 1, wherein the update is released to a percentage of users of the native application, the percentage being less than 100% of all users.

9. The method of claim 8, wherein the percentage is specified by a team managing the at least one component.

10. The method of claim 9, wherein the updating is scheduled by the team managing the at least one component.

11. The method of claim 1, further comprising: updating a second of the multiple components by a second team managing the second of the multiple components.

12. The method of claim 1, wherein the at least one component includes a voice recognition binary or a media player binary.

13. A system comprising:
a memory storing a set of instructions; and
a processor configured to execute the set of instructions to cause the system to:
provide a staged release of multiple components of a native application, the staged release of each component including pushing the component to different groups of users of the native application at different times, and wherein the times are different for different components of the native application; and
update at least one of the multiple components,
wherein the update occurs over multiple channels for each of the multiple components, the multiple channels corresponding to different builds of the native application; and
wherein pushing the component to different groups of users of the native application at different times includes:
receiving an update file including binary content from an updater computer on which the update file was created;
generating an update package from the binary content, the update package being configured to automatically install the component on a device that runs the native application; and
sending the update package to a first group of users at a first time and a second group of users at a second time.

14. The system of claim 13, wherein each of the multiple components is associated with its own unique private key.

15. The system of claim 14, wherein a digital marketplace server stores each unique private key.

16. The system of claim 15, wherein the digital marketplace server stores the multiple components.

17. The system of claim 13, wherein the native application is a web browser.

18. A non-transitory computer readable medium containing instructions that when executed cause a microprocessor of a computer system to:
provide a staged release of multiple components of a native application, the staged release of each component including pushing the component to different groups of users of the native application at different times, and wherein the times are different for different components of the native application; and
update at least one of the multiple components using a digital marketplace server,
wherein the update occurs over multiple channels for each of the multiple components, the multiple channels corresponding to different builds of the native application; and
wherein pushing the component to different groups of users of the native application at different times includes:
receiving an update file including binary content from an updater computer on which the update file was created;
generating an update package from the binary content, the update package being configured to automatically install the component on a device that runs the native application; and
sending the update package to a first group of users at a first time and a second group of users at a second time.

19. The non-transitory computer readable medium of claim 18, wherein the digital marketplace server stores the multiple components and each unique private key associated with each of the multiple components.

20. The non-transitory computer readable medium of claim 18, wherein the native application is a web browser.

21. (canceled)

22. A method comprising:
providing a staged release of multiple components of a native application, the staged release of each component including pushing the component to different groups of users of the native application at different times, each group including less than 100% of users of the native application and wherein the times are different for different components of the native application; and
updating at least one of the multiple components,
wherein the updating occurs over multiple channels for each updated component, the multiple channels corresponding to different builds of the native application;
wherein providing the staged release of the multiple components of the native application includes receiving a file containing content for an update of a component of the multiple components,
wherein each of the multiple components is associated with its own unique private key, and
wherein the method further comprises:
generating, by processing circuitry of a server computer, a key pair including the unique private key of the component of the multiple components and a corresponding public key;
in response to receiving the file containing content for the update of the component, providing, by the processing circuitry, a digital signature to the file using the private key; and
verifying, by the processing circuitry using the private key, that the update of the component relates to a verified component stored in a data store.
